(19) United States
(12) Patent Application Publication
(10) Pub. No.: US 2018/0214834 A1
(43) Pub. Date: Aug. 2, 2018

(54) A PROCESS FOR MANUFACTURING POLYMER COATED, CONTROLLED RELEASE FERTILIZER, AND RELATED SYSTEMS

(71) Applicant: CelluloseTek LLC, Redmond, WA (US)

(72) Inventor: Santosh Yadav, Redmond, WA (US)

(21) Appl. No.: 15/749,405

(22) PCT Filed: Apr. 18, 2016
(86) PCT No.: PCT/US16/28094

§ 371 Date: Jan. 31, 2018

(30) Foreign Application Priority Data
Apr. 21, 2015 (IN) 1629/MUM/2015

(51) Int. Cl. B01J 2/00; B01J 2/26; B05C 13/02

(52) U.S. Cl. CPC B01J 2/006; B05C 13/02; B01J 2/26

(57) ABSTRACT

A frame for holding a small object while coating the small object with a coating composition includes a first plate and a second plate coupled to the first plate and movable relative to the first plate. The first plate includes a platform having a longitudinal axis. The second plate includes a wall adjacent a hole, wherein the hole receives the first plate's platform and is configured to allow the wall to move relative to the platform in a direction along the platform's longitudinal axis. When the first and second plate are coupled together, the first plate's platform and the second plate's wall define a receptacle of the frame that is operable to hold a small object.

### CROSS REFERENCE TO RELATED APPLICATION AND CLAIM OF PRIORITY

This application claims priority from the commonly owned India Provisional Patent Application 1629/MUM/2015 filed 21 Apr. 2015, and titled “Process for Manufacturing Polymer Coated Controlled-Release Fertilizers”, presently pending and incorporated by reference.

### BACKGROUND

Often animals and plants need to consume material to help them grow, cure an illness, and/or correct an abnormality or deficiency. Animals often consume such material by ingesting a pharmaceutical pill so that their gut can absorb the material. Plants often consume such material by absorbing a fertilizer through their leaves and/or roots. To help animals and plants consume such material, the material is often formed into a small object, such as a pellet, granule, or pill, and then either ingested by an animal or applied on or near a plant. To help control the rate at which the animal and plant absorb the material, such small objects are often coated with a material that is more inert than the material to be absorbed by the animal or plant. Because of the similarities between animals consuming a pharmaceutical pill and a plant consuming a fertilizer, the following discussion of fertilizers also applies to pharmaceutical pills.

Fertilizer is organic or inorganic material of natural or synthetic origin that is added to a soil to supply one or more plant nutrients essential for the growth of a plant. Fertilizers are broadly divided into organic fertilizers (composed of plant or animal matter) and inorganic/commercial fertilizers. A plant absorbs the required nutrients after the fertilizer has dissolved. Both organic and inorganic fertilizers provide the chemical compounds that are needed by a plant. Organic fertilizers provide both macro and micro nutrients that are released as the organic matter decays. The decay may take months or years. Organic fertilizers often have lower concentrations of plant nutrients and are often difficult/expensive to collect, treat, transport, and distribute. Inorganic fertilizers are often readily dissolved and applied to the soil, and readily absorbed by a plant.

Most of the commercially available fertilizers, when applied to a lawn or agricultural crop, dissolve rapidly in the moisture of the soil. Often, such fertilizers dissolve at a rate that exceeds the rate at which it is absorbed by the plants. This causes a number of problems. First, the excess fertilizer can leach into the groundwater and potentially cause serious damage to the environment. In addition, an excessive concentration of the fertilizer in the vicinity of a plant may burn or damage the plant and/or roots. To address these problems, fertilizer is often applied in several light doses throughout the growing season, rather than a single heavy dose. However, the need for repeated applications increases the labor, and thus the cost, of growing the crop. In addition, repeated applications of a fertilizer require fertilizer-spreading equipment to make multiple passes over the field where the crops grow, which increases the risk that the equipment will physically damage some of the crop.

In order to minimize the loss of fertilizer into the environment and to avoid the need for repeated applications, a variety of slow or controlled release fertilizers have been developed. These fertilizers are applied at the beginning of the growing season to facilitate a higher release of fertilizer in the initial growing period followed by a slower release or gradual release of fertilizer throughout the growing season. The slow or controlled release fertilizers are widely used on the agriculture crops, home lawns, public lawns, golf courses, home gardens, plant nurseries, and for horticultural crops.

Technically advanced controlled-release fertilizers include polymer-coated fertilizers, which are typically produced by coating a water-insoluble, semi-permeable polymer layer onto a fertilizer granule. The fertilizer is released over a period into the soil by diffusion through this semi-permeable polymer layer.

A method for manufacturing a polymer-coated fertilizer includes reacting chemical monomers onto the surface of a granule to form a polymer film. This method is called reactive-layer coating in which a polyurethane polymer is formed. Another popular method for manufacturing a polymer-coated fertilizer includes spraying a solution of a polymer onto a fertilizer granule and then evaporating off the solvent to form a polymer-film coating. This method is called fluidized-bed coating and requires an expensive solvent and a system to recover the evaporated solvent.

The most critical aspect of controlled-release fertilizers is the moisture permeability of the coating, which is affected by the thickness of the polymer coating. The release of fertilizer takes place via diffusion through the coating and the uniformity of the release rate depends on the uniformity of the coating's thickness. An uneven coating will cause an uneven rate of moisture transmission, and hence affect the quality of the controlled-release product.

There are many problems or shortcomings with these existing coating technologies. One such problem is that these coating processes spray polymer solution onto a plurality of fertilizer granules which are tumbling and rolling in a random fashion inside a rotary drum, or in a vertical column of a fluidized bed. The uneven-shaped granules produce a completely random rolling pattern, and thus the coating cannot be directed. This results in an uneven coating thickness. This problem worsens when the shape is extremely uneven or non-spherical such as the fertilizer products made by a compaction process, which have a highly uneven shape. Thus, all existing coating technologies require an expensive premium-grade, round granule with a smooth surface to minimize non-uniformity of the coating.

Other such problems with these coating technologies are that they are either polymer specific, such as processes that apply a polyurethane coating, or require an expensive solvent to apply the coating in a fluidized bed. These methods also produce products that are very expensive—sometimes the cost is equal to 4-6 times the price of a conventional fertilizer. A big reason for their expense is the use of an expensive polymer, the use of an expensive solvent, or both. Another such problem is that most of these manufacturing processes are batch-type processes, which also increase the cost to produce the fertilizer.

Another such problem with these coating technologies is that they often require multiple applications of a polymer to increase the thickness of the polymer coating around the fertilizer. For example, nearly 16 applications of a polyurethane polymer are needed to achieve a coating thickness of 8%. A coating thickness 0.5% is achieved in each application and hence more time and energy are required for multiple applications thereby increasing the production cost.

Yet another such problem with these coating technologies is that the fertilizer granules with lower compression or crushing strength cannot be coated due to turbulence in the coating system.

Thus, there is a need for a system and a method for continuous production-run (not batch-type) manufacturing of a polymer-coated, controlled-release fertilizer having any shape and form, and having a uniform coating thickness. Similarly, there is a need for a system and a method for continuous production-run (not batch-type) manufacturing of a coated, controlled-release medicine pill having any shape and form, and having a uniform coating thickness.

### SUMMARY

In an aspect of the invention, a method for coating a small object with a coating composition includes moving a first frame in a first direction, the first frame having a plurality of receptacles disposed in an orderly arrangement that move with the first frame. Then, while the first frame is moving, positioning a small object in a respective one of the first frame's plurality of receptacles such that a region of the small object contacts the receptacle. Then, while the first frame is moving, applying a coating composition onto the small object. The method also includes moving a second frame in a second direction, the second frame having a plurality of receptacles disposed in an orderly arrangement that move with the second frame. Then, while the first and second frames are moving, transferring the small object from the first frame's receptacle to a respective one of the second frame's plurality of receptacles, and positioning the small object such that the region of the small object that contacted the first frame's receptacle does not contact the second frame's receptacle. Then, while the second frame is moving, applying a coating composition onto the small object.

In another aspect of the invention, a frame for holding a small object while coating the small object with a coating composition includes a first plate and a second plate coupled to the first plate and movable relative to the first plate. The first plate includes a platform having a longitudinal axis. The second plate includes a wall adjacent a hole, wherein the hole receives the first plate's platform and is configured to allow the wall to move relative to the platform in a direction along the platform's longitudinal axis. When the first and second plate are coupled together, the first plate's platform and the second plate's wall define a receptacle of the frame that is operable to hold a small object.

Because the frame's receptacle is defined by the first plate's platform and the second plate's wall, which moves relative to the platform, a small object, such as a spherical or oblong pellet/granule of fertilizer, or a spherical or oblong pharmaceutical pill may be easily positioned and held in the receptacle while the small object is moved to multiple locations where a coating composition may be evenly applied to the small object. Thus, the frame allows one to use a continuous-run method to produce a uniformly coated small object.

### BRIEF DESCRIPTION OF THE DRAWINGS

FIG. 1 shows a view of a system for coating a small object with a coating composition, according to an embodiment of the invention.

FIG. 2 shows two partial, cross-sectional views of a frame of the system shown in FIG. 1 holding a small object, according to an embodiment of the invention.

FIG. 3 shows two cross-sectional views of a small object with a coating composition that the system shown in FIG. 1 applied, according to an embodiment of the invention.

FIG. 4 shows a perspective view of the frame shown in FIGS. 1 and 2, according to an embodiment of the invention.

FIG. 5 shows a cross-sectional view of a first plate of the frame shown in FIGS. 1, 2 and 3, according to an embodiment of the invention.

FIG. 6 shows a cross-sectional view of a second plate of the frame shown in FIGS. 1, 2 and 3, according to an embodiment of the invention.

FIG. 7 shows a partial, cross-sectional view of an interface of the system shown in FIG. 1, according to an embodiment of the invention.

FIG. 8 shows a perspective view of a frame, according to another embodiment of the invention.

### DETAILED DESCRIPTION

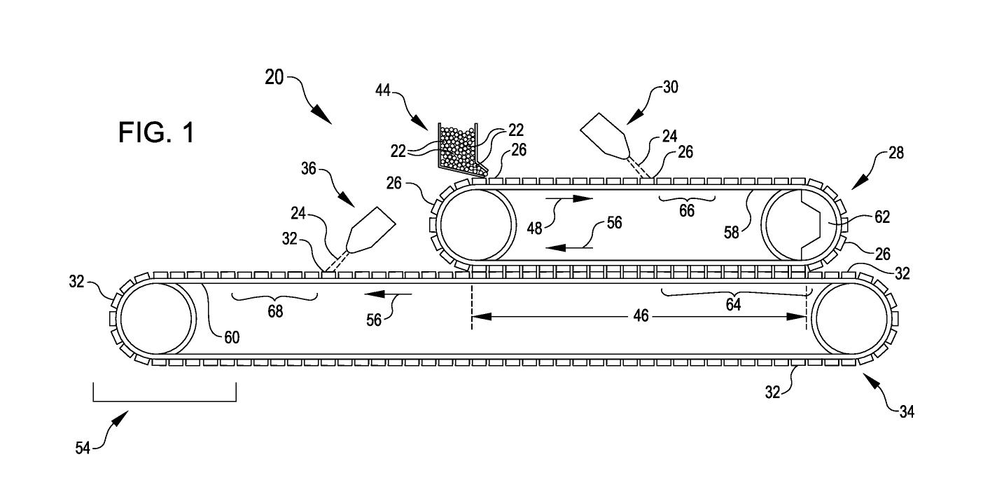

FIG. 1 shows a view of a system 20 for coating a small object 22 with a coating composition 24, according to an embodiment of the invention. The small object 22 (only three labeled for clarity) may be any small object having any shape. For example, the small object 22 may be fertilizer, pesticide or fertilizer and pesticide combination products in the shape of a pellet, a granule, a spike, a briquette, or a nodule. Similarly, the small object 22 may be a pharmaceutical pill in the shape of a disc, a capsule or a sphere. Similarly, the small object 22 may be a detergent, a biocide, a soil pH modifying agent such as aluminum sulfate, a plant growth hormone, a seed and/or a nutraceutical in the shape of a tablet, a pellet or a granule. Likewise, the coating composition 24 (discussed in greater detail in conjunction with FIG. 3) may be any desired composition that performs a desired function. For example, the composition may include a polymer, a processing additive, a plasticizer, a wax, a co-initiator or cure catalyst, an antioxidant, a tackifier, a mineral filler, a pigment, a lubricant, and/or a taggant.

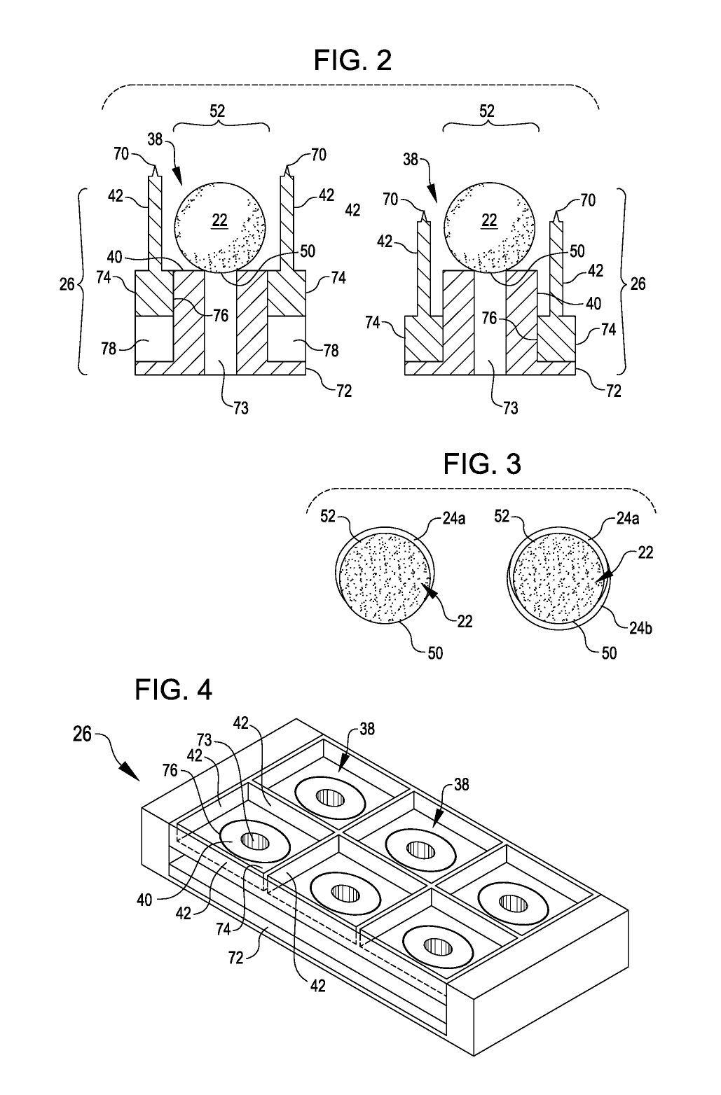

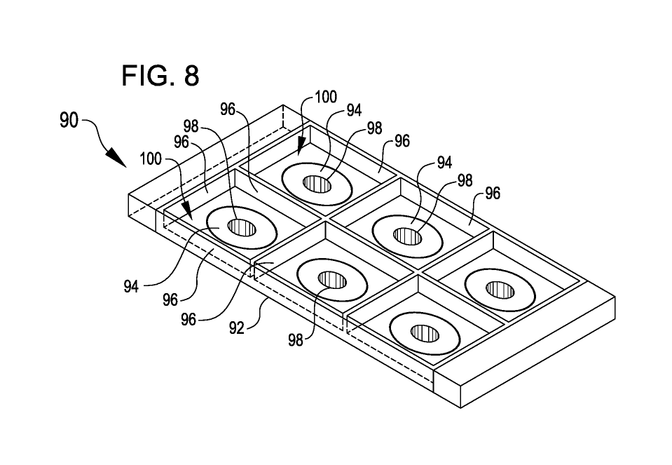

The system 20 includes a first frame 26 carried by a first conveyor 28 toward an applicator 30 that may apply a coating composition to a region of the small object 22, and a second frame 32 carried by a second conveyor 34 toward an applicator 36 that may apply a coating composition to another region of the small object 22. Each of the first and second frames 26 and 30 (discussed in greater detail in conjunction with FIGS. 2, 4, 5, 6 and 8) includes a plurality of receptacles (38 in FIG. 2) disposed in an orderly arrangement. Each receptacle 38 is configured to receive a small object 22 and is defined by a platform (40 in FIG. 2) and a wall (42 in FIG. 2). In some embodiments (FIGS. 2, 4, 5 and 6), the wall 42 is movable relative to the platform 40; and in other embodiments (FIG. 8), the wall 42 is not movable relative to the platform 40. The system 20 also includes a distributor 44 to position small objects 22 into a respective receptacle 38 of the first frame 26, and a transfer interface 46 where the small objects 22 may be transferred to the second frame 32 and carried toward the applicator 36 by the second conveyor 34.

In operation, the first conveyor 28 moves a first frame 26 in the direction indicated by the arrow 48. While the first frame 26 is moving, the distributor 44 positions a small object 22 in a receptacle 38 of the first frame 26 such that a region 50 (FIG. 2) of the small object 22 contacts the receptacle 38 while another region 52 (FIG. 2) of the small object 22 is exposed. As the first conveyor 28 continues to move the first frame 26, the applicator 30 applies a coating composition to the exposed region 52 of the small object 22. The first conveyor 28 then moves the first frame 26 toward the transfer interface 46. As the first frame 26 moves through the transfer interface 46, the second conveyor 34 moves a second frame 32 through the transfer interface 46. While the two frames 26 and 32 move through the transfer interface 46, the small object 22 carried by the first frame 26 is transferred to and positioned in (discussed in greater detail in conjunction with FIG. 7) a receptacle of the second frame 32. The small object 22 is positioned in the second frame's receptacle such that the small object's region 50 that contacted the receptacle 38 of the first frame 26 is now exposed, and the small object's region 52 that was exposed now contacts the second frame's receptacle. The second conveyor 34 then moves the second frame 32, and thus the small object 22, toward the applicator 36. As the second conveyor 34 moves the second frame 32, the applicator 36 applies a coating composition 24 to the now exposed region of the small object 22. Finally, the coated small objects 22 are collected at the collector 54.

Because the wall 42 of each receptacle 38 moves relative to the platform 40 of each receptacle 38, a small object 22 may be easily positioned and held in the receptacle 38 while the small object 22 is moved to the applicator 30 and 36 of the system 20 to have a coating composition evenly applied to it. In addition, the small object 22 may be easily transferred to and positioned in the second frame's receptacle so that the exposed region of the small object 22 is the region that was not exposed before the transfer. Thus, the frames 26 and 32 allow one to use a continuous-run method to produce a uniformly-coated small object 22.

Still referring to FIG. 1, the first conveyor 28 may be oriented relative to the second conveyor 34 as desired. For example, in this and other embodiments of the system 20, the first conveyor 28 lies above and adjacent the second conveyor 34. In this arrangement, the length of the system 20, and thus the amount of floor space or the system's foot print, may be reduced to the length of the second conveyor 34. In addition, the direction that the second conveyor 34 moves the second frame 32, which is indicated by the arrow 56, is opposite the direction that the first conveyor 28 moves the first frame 26. The transfer interface 46 is the length of the first conveyor 28, and the first conveyor 28 moves the first frame 26 in the direction indicated by the arrow 56 to facilitate the transfer of the small object 22 from the first frame 26 to the second frame 32. In other embodiments, the first and second conveyors 28 and 34, respectively, may not lie in the same vertical plane. And, the two conveyors 28 and 34 may not lie adjacent each other, and thus, the transfer interface 46 may include a component that lies between the two conveyors 28 and 34.

The first and second conveyors 28 and 34, respectively, may be any desired conveyor capable of moving their respective frames 26 and 32. For example, in this and other embodiments, the first conveyor 28 is a conventional conveyor system that moves the first frame 26 along an oblong circular path. To couple the first frame 26 to the first conveyor 28, the first frame 26 may be bolted to the conveyor belt 58. Similarly, the second conveyor 34 is a conventional conveyor system that moves the second frame along an oblong circular path. To couple the second frame 32 to the second conveyor 34, the second frame 32 may also be bolted to the conveyor belt 60. In other embodiments, the first and second conveyors 28 and 34 may move their respective frames 26 and 32 along different paths, such as a rectangular path or a non-oblong circular path.

Still referring to FIG. 1, the small object 22 may be held in the first and second frame's receptacle using any desired technique. For example, in this and other embodiments, gravity holds the small object 22 in the first frame's receptacle 38 as the frame 26 moves from the distributor 44 past the applicator 30. Then, as the frame 26 is moved toward the direction indicated by the arrow 56, a vacuum is applied to the receptacle 38 to hold the small object 22 in the receptacle 38. The vacuum is applied while the receptacle 38 travels through the region 62 of the first conveyor 28 to counter the effect of gravity urging the small object 22 out of the receptacle 38. Similar to the first frame 26, gravity holds the small object 22 in the second frame's receptacle as the second frame 32 moves from the interface transfer 46 past the applicator 36. To help transfer the small object 22 from the first frame's receptacle 38 to the second frame's receptacle, a vacuum is applied to the second frame's receptacle while the receptacle travels through the region 64 of the second conveyor 34. The region 64 is positioned so that it begins where the region 62 of the first conveyor 28 ends so that the small object 22 moving into the transfer interface 46 experiences a vacuum from the second frame's receptacle as the vacuum from the first frame's receptacle ends. In this manner, the region 50 of the small object 22 that contacted the first frame's receptacle 38 becomes the exposed region as the small object 22 travels through the applicator 36.

Still referring to FIG. 1, the applicators 30 and 36 may be any desired applicators capable of applying a coating composition on the small object 22. For example, in this and other embodiments, each of the applicators 30 and 36 includes an extruder that extrudes a film of the coating compound over the small object 22 as the receptacle moves underneath the applicators 30 and 36. Then, while the receptacle 38 travels through the region 66 of the first conveyor 28 and then region 68 of the second conveyor 34, a vacuum is applied to the receptacle to help apply the film of the coating composition to the respective exposed regions of the small object 22. Each of the applicators 30 and 36 may also include a heater (not shown) to soften the film to help apply the coating composition to the exposed region of the small object. In such and other embodiments, the wall 42 of the receptacle 38 may include an edge 70 (see FIG. 2) to cut the film, and/or the wall 42 may be heated to also help soften the film.

In other embodiments of the system 20, each of the applicators 30 and 36 may include a nozzle that sprays the coating composition onto the respective exposed regions of the small object 22. The nozzle may be configured to spray a molten coating composition or a solution of the coating composition dissolved in a solvent. The temperature of the coating composition may range from 40° C. to 400° C. In yet another embodiment of the system 20, the applicators 30 and 36 may include an electrostatic powder-coating system. In this embodiment the powder mixture adheres to the surface of the fertilizer granules and may be heated by an infrared heater to melt and fuse the powder into a film on the small object. In yet another embodiment of the system 20, each of the applicators 30 and 36 may include an ultraviolet or electron beam curing system in which a two-part epoxy based coating composition may be cured by ultraviolet radiation and/or an electron beam.

In other embodiments of the system 20, each of the applicators 30 and 36 may be a polymer film feeding unit that applies a layer of preformed polymer film 24 onto the respective exposed regions of the small object 22. The polymer film is heated and softened by a suitable heater (not shown) before applying the film onto the respective exposed regions of the small object 22.

Other embodiments of the system 20 are possible. For example, one or both of the conveyors 28 and 34 may include more than one applicator 30 and 36, respectively. In addition, each of the applicators 30 and 36 may be different than the other. Also, one or both of the conveyors 28 and 34 may include a system for removing dust from the surface of the small object just before the coating composition is applied. Dust may interfere in the adhesion of the coating onto the surface and may cause the coating to separate from the small object. The dusting system may include a pressurized air nozzle. In yet other embodiments one or more of the conveyors 30 and 36 may include a surface-priming system to prepare the small object's surface for coating. Any surface priming methods such as corona treatment, surface heat treatment, surface etching, plasma treatment, adhesive spray may be employed.

FIG. 2 shows two partial, cross-sectional views of a frame 26 of the system 20 shown in FIG. 1 holding a small object 22, according to an embodiment of the invention. The left view shows the first frame's wall 42 moved to a position relative to the first frame's platform 40; and the right view shows the first frame's wall 42 moved to another position relative to the first frame's platform 40. In this and other embodiments, the first and second frames 26 and 32, respectively, are similar, and thus, the discussion of the first frame 26 and its receptacles 38 applies to the second frame 32 and the second frame's receptacles.

As previously mentioned, the first frame 26 includes a plurality of receptacles 38 each configured to receive a small object 22 and each defined by a platform 40 and a wall 42. The first frame 26 may include any desired number of receptacles 38 disposed in any desired orderly arrangement. For example, as shown in FIG. 4, in this and other embodiments, the first frame 26 includes six receptacles 38 arranged in two rows of three. When moved by the first conveyor 28, the first row of three receptacles 38 passes the applicator 30 at the same time, and then the second row of three receptacles 38 passes the applicator 30. In other embodiments, the first frame 26 may include six receptacles 38 arranged in three rows of two. In still other embodiments, the first frame 26 may include 91 receptacles 38 arranged in seven rows of thirteen. In still other embodiments, the first frame 26 may include 25 receptacles 38 arranged in five arcs or curved rows of five.

The first frame 26 may be configured as desired to allow the wall 42 and platform 40 to be moved relative to each other. For example, in this and other embodiments, the first frame 26 includes a first plate 72 that is coupled to the first conveyor's conveyor belt 58, and a second plate 74 that is movable relative to the first plate, while the first conveyor 28 moves the first plate 72. The first plate 72 includes a number of platforms 40 each having a bore 73 in which a vacuum may be generated to hold the small object 22 to the platform 40. The number of platforms 40 equals the number of receptacles 38 to be included in the first frame 26. So, if the first frame 26 includes one receptacle 38, then the first plate 72 would include one platform 40. Similarly, the second plate 74 includes a number of holes 76 and a number of walls 42 both equal to the number of receptacles 38 to be included in the first frame 26. So, if the first frame 26 includes one receptacle 38, then the second plate 74 would include one hole 76 and one wall 42. When the first plate 72 and the second plate 74 are coupled together, the first plate's platform 40 extends into the second plate's hole 76, and when the second plate 74 moves relative to the first plate 72, the platform 40 slides in the hole 76 as shown by the two views in FIG. 2.

The second plate 74 may be moved relative to the first plate 72 in any desired manner. For example, in this and other embodiments, a hydraulic pump (not shown) pumps hydraulic fluid 78 into a cavity between the two plates 72 and 74 to move the wall 42 away from the platform 40. To move the wall 42 toward the platform 40, the hydraulic fluid is allowed to escape the cavity, and thus, allow the weight of the second plate 74 to push the hydraulic fluid out of the cavity. A switch (not shown) located at a desired location on the path of the first conveyor 28 may trigger a valve to open a conduit between the cavity and the high-pressure hydraulic fluid to allow the high-pressure hydraulic fluid into the cavity. Another switch (not shown) located at another desired location on the path of the first conveyor 28 may trigger the open valve to close and may trigger another valve to open a conduit between the cavity and low-pressure hydraulic fluid to allow the hydraulic fluid in the cavity to leave the cavity.

When the first frame 26 moves in the direction indicated by the arrow 56 in FIG. 1, the first frame's orientation relative to the direction of gravity is the opposite of its orientation while it moves in the direction indicated by the arrow 48 in FIG. 1. Thus, gravity urges the second plate's wall 42 to extend away from the first plate's platform, not toward it. So, to prevent the second plate's wall 42 from extending away from the first plate's platform and interfering with the transfer of the small object from the first frame 26 to the second frame 32, a cam or wedge may be used in the first conveyor 28 while the first frame 26 is moved in the direction indicated by the arrow 56.

Other embodiments are possible. For example, the second plate 74 may be moved relative to the first plate 72 by a pneumatic circuit that urges the two plates away from and toward each other. As another example, the cam or wedge may move the second plate 74 relative to the first plate 72 while the first and second plates 72 and 74, respectively are moved in the direction indicated by the arrow 48 in FIG. 1.

FIG. 3 shows two cross-sectional views of a small object 22 with a coating composition 24 that the system 20 shown in FIG. 1 applied, according to an embodiment of the invention. The left view shows the small object 22 after it has passed the first conveyor's applicator 30, but before it has passed the second conveyor's applicator 36. The right view shows the small object 22 after it has passed the second conveyor's applicator 36. In the left view, the first conveyor's applicator 30 has applied a coating composition 24a to the region 52, which is the region shown exposed in FIG. 2. In the right view, the second conveyor's applicator 36 has applied a coating composition 24b to the region 50, which is the region shown contacting the platform 40 in FIG. 2. The coating composition 24b applied by the second conveyor's applicator 36, overlaps and fuses with the coating composition 24a to complete the coating of the small object 22.

As previously mentioned, the coating composition 24 may be any desired composition that performs a desired function. For example, the composition may include a polymer, a processing additive, a plasticizer, a wax, a co-initiator or cure catalyst, an antioxidant, a tackifier, a mineral filler, a pigment, a lubricant, and/or a taggant. More specifically, the coating composition 24 may be a single component or a mixture or blend of two or more components, and may be a solution, a paste, a melt, or a dry film, or a powder. As a melt the majority component is in a molten state and the rest of the constituents (if any) are either in a molten state or dispersed or dissolved in the composition 24. As a solution the components of the composition 24 are either dissolved or suspended in a solution (aqueous or non-aqueous). As a dry film the constituents of the coating composition 24 are pre-made into a film that may contain all of the constituents in its structure. As a dry powder the coating composition 24 is a fine powder and the constituents of the coating composition 24 are mixed in the powder mix.

In some embodiments the coating composition 24 includes a polymer that may be a biodegradable or a non-biodegradable thermoplastic resin of natural or synthetic origin, a thermoplastic elastomer, a thermosetting resin, an alkyd resin, an ultraviolet or electron-beam curable resin, a biopolymer, and a natural polymer, their copolymer or blend. The thermoplastic polymer may be selected from a group that includes: polyacetals, nylons, polyethylene (PE) of different molecular weights and densities, polypropylene (PP), polystyrene (PS), polyvinyl chloride (PVC), polymethylmethacrylate (PMMA or acrylic), acrylonitrile butadiene styrene (ABS), polycarbonate (PC), polyesters, polyethylene terephthalate (PET), polybutylene terephthalate (PBT), polyamide (PA or nylon), polyphenylene sulfide (PPS), polyphenylene oxide/polystyrene blend, polyetherimide (PEI), polysulfone (PSO), and their blends and copolymers. In other embodiments, a thermoplastic elastomer polymer may be selected from a group that includes: styrene-butadiene rubber, butadiene rubber, isoprene, butyl rubber, chloroprene rubber, nitrile rubber, ethylene-propylene rubber (EPM and EPDM), silicon rubbers, polyureas, polyurethanes, or their blends or derivatives. In other embodiments, a biodegradable thermoplastic polymer may be selected from a group that includes: polyglycolide (PGA), polylactide-co-glycolide (PLGA), polybutylene succinate (PBS) and its copolymers, polyp-dioxanone (PDO or PPDO), polycaprolactone (PCL), polyhydroxyalkanoates (PHA), polyhydroxybutyrate (PHB), polyhydroxyvalerate (PHV), polylactic acid (PLA), biodegradable polycarbonate, polyvinyl alcohol (PVOH), polyvinyl acetate (PVA), and their copolymers and derivatives. In other embodiments, a biopolymer or natural polymer may be selected from a group that includes: cellulose derivatives, polysaccharides, chitin and chitosan polymers, proteins, or gelatins. In other embodiments, a thermosetting polymer may be selected from a group that includes: unsaturated polyesters, phenolic resins, amino resins, urea/formaldehyde resins, polyurethanes, polyureas, epoxy resins, or silicones. Less common thermosets employed in specialized applications may be polybismaleimides, polyimides, and polybenzimidazoles.

The composition coating 24 may include any polymer that has melt-flow index (MFI) between 0.1 to 5000. And, the coating composition 24 may have a viscosity that ranges between 1.0 centipoise and 2,000,000 centipoises, and may range between 40° C. and 400° C. during its application.

In yet other embodiments, the coating composition 24 may include: a polymer for cohesive strength, a wax, a tackifier, an anti-block additive, and/or other processing additives such as anti-oxidatives, mineral fillers, and/or superabsorbent particles.

Polymers for cohesive strength may be selected from a group that includes: styrenic block copolymers, polyolefins (e.g., amorphous and crystalline polyolefin including homogeneous and substantially linear ethylene/alpha-olefin inter-polymers), interpolymers and copolymers of ethylene including, e.g., ethylene-vinyl acetate, ethylene-vinyl acetate ethylene-acrylic acid, ethylene-methacrylic acid, ethylene-methyl acrylate, ethylene-ethyl acrylate and ethylene n-butyl acrylate and derivatives (e.g., incorporating at least two comonomers), polyacrylic acids, polymethacrylic acids, polyacrylates, polyvinyl acetates, polylactic acids, polylactides, caprolactone polymers, poly (hydroxy-butyrate/hydroxyvalerate), polyvinyl alcohols, polyesters, copolyesters (e.g., biodegradable copolyesters), polyethylene oxidepolyether amide, polyester ether block copolymers, polyvinyl pyrrolidone, polyvinyl pyrrolidone-vinyl acetate copolymer, polyetheroxazoline, polyvinyl ethers (e.g., polyvinyl methyl ether), polyamides, polyurethane, polyacrylamide, Polyesters and combinations and blends thereof.

Waxes may be selected from a group that includes: paraffin waxes, Fischer-Tropsch waxes, by-product polyethylene waxes, high-density low molecular weight polyethylene waxes, microcrystalline waxes, vegetable waxes, and combinations thereof.

Tackifying resins or tackifiers are used to modify the tackifying, wetting, and adhesion characteristics of a polymer. Tackifying resins also function to control viscosity, as well as wetting and adhesion. These are usually low-molecular-weight polymers based on aliphatic or aromatic hydrocarbons, rosins, rosin esters, terpenes, styrene or phenol derivatives, or any of these in combination. The formulations include stabilizers and anti-oxidants to prevent premature viscosity change and char or gel formation that could foul one or more components of the system 20. A tackifier may be selected from a group that includes: rosin ester, rosin acid, styrenated terpene, terpene-phenolic resin, aliphatic hydrocarbon resin, aromatic-modified aliphatic resin, aromatic hydrocarbon resin, α-methyl styrene resin, hydrogenated hydrocarbon resin, and aromatically-modified hydrocarbon resin.

In yet other embodiments, the coating composition 24 may include a taggant marker, which may be chosen from a group of chemical and/or physical taggants. In addition, the coating composition 24 may include a laser etching that is subsequently covered by additional coating composition 24. The etching can be conducted on either or both the surfaces of the coatings.

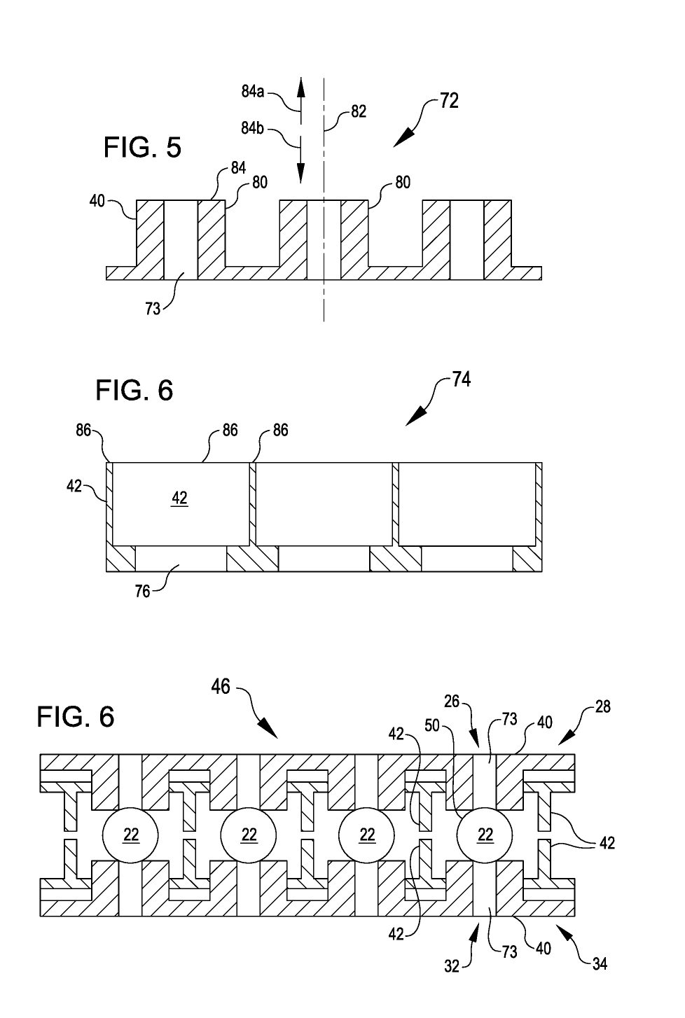

FIG. 4 shows a perspective view of the first frame 26 shown in FIGS. 1 and 2, according to an embodiment of the invention. FIG. 5 shows a cross-sectional view of a first plate 72 of the first frame 26 shown in FIG. 4, according to an embodiment of the invention. And FIG. 6 shows a cross-sectional view of a second plate 74 of the first frame 26 shown in FIG. 4, according to an embodiment of the invention.

The receptacle 38 may be configured as desired to hold any desired form of the small object 22. For example, in this and other embodiments, the receptacle 38 is rectangular, the first plate's platform 40 defines most of the receptacle's floor, and the second plate's wall 42 surrounds the receptacle's floor. With the platform 40 defining most of the receptacle's floor and the wall 42 surrounding the receptacle's floor, an object 22 that fits within the receptacle 38 can have a variety of different forms yet be properly held on the platform 40 while: 1) the applicator 30 (FIG. 1) applies a coating composition 24 (FIG. 3) to a region 52 (FIG. 2) of the object, 2) the object is transferred to the second frame 32 (FIG. 1), and 3) the applicator 32 applies a coating composition 24 to the region 50 (FIG. 2). In other embodiments, the platform 40 may define less than 50% of the area of the receptacle's floor, and the wall 42 may not surround the platform 40. For example, the wall 42 may extend around half of the platform's perimeter and may continuously extend around half to form a single wall or may not continuously extend around half of the platform to form two or more separate walls.

Referring to FIG. 5, the platform 40 of the first plate 72 may be configured as desired to help hold a small object 22. For example, in this and other embodiments, the platform 40 includes a cylindrical shape, more specifically a cylinder 80. The cylinder 80 includes a longitudinal axis 82 and a diameter sized to fit into the second plate's hole 76 such that the hole 76 and the second plate 74 may move in the directions 84a and 84b along the cylinder's longitudinal axis 82 when the second plate 74 moves relative to the first plate 72. The cylinder also includes a surface 84 that contacts the small object 22 when the object 22 is in the receptacle 38. Here, the surface 84 is substantially flat and substantially perpendicular to the cylinder's longitudinal axis 82.

Other embodiments are possible. For example, the platform 40 may include a rectangular shape such as a square or rectangle. As another example, the platform 40 may include a triangular shape. In addition, the platform 40 may have a surface 84 that is curved such as concave relative to the remainder of the platform 40. Also, the orientation of the platform's surface 84 may be angled other than 90° relative to the remainder of the platform 40.

Referring to FIG. 6, the wall 42 of the second plate 74 may be configured as desired to help hold a small object 22. For example, in this and other embodiments, the wall 42 includes four sides 86 (only three shown), each having the same height and similar rectangular cross-sections. In other embodiments, the height of each side may be different than the other, and the cross-sections of each side may be triangular or rhomboidal or trapezoidal.

FIG. 7 shows a partial, cross-sectional view of the transfer interface 46 of the system 20 shown in FIG. 1, according to an embodiment of the invention. At the transfer interface 46, the small object 22 is transferred from the first frame 26 carried by the first conveyor 28 to the second frame 32 carried by the second conveyor 34. During this transfer, the small object 22 is positioned in the second frame's receptacle such that the small object's region 50 that contacted the receptacle 38 of the first frame 26 will be exposed when the small object 22 exits the transfer interface 46, and the small object's region 52 that was exposed will contact the second frame's receptacle.

The transfer interface 46 may be configured as desired to transfer the small object 22 and properly orient the small object 22 as the second conveyor 34 moves it toward the applicator 36 (FIG. 1). For example, in this and other embodiments, the first and second conveyors 28 and 34, respectively, are configured so that as they move their respective frames 26 and 32 through the transfer interface 46, each of the first frames 26 aligns with a corresponding second frame 32, and all of the frames 26 and 32 travel at the same speed. The transfer to the second frame 32 is made at the beginning of the transfer interface after the first and second frames 26 and 32 align. At this moment, the vacuum through the bores 73 of the first frames 26 stops as shown by the end of the region 62 (FIG. 1) and a vacuum in the bores 73 of the second frames 32 is generated. To properly position the small object 22 in the second frame's receptacle, the first frame 26 is located adjacent the second frame 32 as the two align; then the vacuum generated in the second frame's bore 73 pulls the small object directly to the second frame's platform. In other embodiments, hot air may be blown through the frame 26 during the transfer of the object 22. Because the frames 26 and 32 are adjacent each other during the transfer, the small object 22 doesn't have an opportunity to rotate before the vacuum in the second frame 32 holds it against the second frame's platform 40.

In this and other embodiments, the distance between the two frames 26 and 32 while they travel through the transfer interface 46 is such that both of the platforms 40 contact the small object at the same time. This works well when the small objects 22 being coated by the system 20 are each very close to the same size and shape. To account for significant variations in the size of the small objects 22, the distance between the two frames 26 and 32 while they travel through the transfer interface 46 may be greater than the size of the small object 22. In this manner, the small object 22 may move away from the first frame 26 and toward the second frame 32 during its transfer to the second frame 32.

Still referring to FIG. 7, in this and other embodiments the walls 42 of each of the first and second frames 26 and 32, respectively, move relative to their respective platforms 40 to form a curtain around the transfer. This helps contain the small object 22 during its transfer to the second frame 32. In other embodiments, the walls 42 may not form a curtain around the small object's transfer.

FIG. 8 shows a perspective view of a frame 90, according to another embodiment of the invention. The frame 90 is similar to the first frame 26 and second frame 32 except that the frame 90 includes one plate 92, not two plates. For example, in this and other embodiments, the plate 92 includes a pedestal 94 and a wall 96 that is not movable relative to the pedestal 94, unlike the wall 42 of the plate 74 (FIG. 4) which is movable relative to the pedestal 40 of the plate 72 (FIG. 4). Similar to the pedestal 40, the pedestal 94 includes a bore 98 through which a vacuum may be generated to help hold a small object positioned in the receptacle 100. Also similar to the plates 72 and 74 of the frame 26 (FIG. 4), the receptacle 100, the wall 96, and the pedestal 94 may be configured as desired.

The preceding discussion is presented to enable a person skilled in the art to make and use the invention. Various modifications to the embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. A method for coating a small object with a coating composition, the method comprising:
moving a first frame in a first direction, the first frame having a plurality of receptacles disposed in an orderly arrangement that move with the first frame;
while the first frame is moving, positioning a small object in a respective one of the first frame's plurality of receptacles such that a region of the small object contacts the receptacle;
while the first frame is moving, applying a coating composition onto the small object;
moving a second frame in a second direction, the second frame having a plurality of receptacles disposed in an orderly arrangement that move with the second frame;
while the first and second frames are moving:
transferring the small object from the first frame's receptacle to a respective one of the second frame's plurality of receptacles, and
positioning the small object such that the region of the small object that contacted the first frame's receptacle does not contact the second frame's receptacle; and
while the second frame is moving, applying a coating composition onto the small object.

2. The method of claim 1 wherein the first frame's orderly arrangement includes a rectangular arrangement having three receptacles disposed side-by-side and substantially perpendicular to the first direction that the first frame moves in.

3. The method of claim 1 wherein moving the first frame in the first direction includes moving the first frame in a direction that is opposite the second direction that the second frame moves in.

4. The method of claim 1 wherein moving the first frame includes moving the first frame along an oblong, circular path.

5. The method of claim 1 wherein positioning a small object in a respective one of the first frame's plurality of receptacles includes positioning a single object into the receptacle.

6. The method of claim 1 wherein positioning a small object in a respective one of the first frame's plurality of receptacles includes dropping at least one of the following: a pellet, a spike, a granule, a briquette and a nodule, into the receptacle.

7. The method of claim 1 wherein positioning a small object in a respective one of the first frame's plurality of receptacles includes positioning the small object on a platform of the receptacle that is movable relative to a wall of the receptacle.

8. The method of claim 1 wherein applying a coating composition onto the small object includes at least one of the following: spraying, melting, melt extruding, thermal laminating, and powder coating.

9. The method of claim 1 wherein applying a coating composition onto the small object includes cutting the coating composition with an edge of a wall of the receptacle.

10. The method of claim 9 wherein cutting the coating composition with an edge of a wall of the receptacle includes moving the receptacle's wall.

11. The method of claim 1 wherein applying a coating composition onto the small object includes at least one of the following: a polymer, a processing additive, a plasticizer, a wax, a co-initiator or cure catalyst, an antioxidant, a tackifier, a mineral filler, a pigment, a lubricant, and a taggant.

12. The method of claim 1 wherein the second frame's orderly arrangement includes a rectangular arrangement having three receptacles disposed side-by-side and substantially perpendicular to the second direction that the second frame moves in.

13. The method of claim 1 wherein moving the second frame in the second direction includes moving the second frame at the same speed that the first frame moves.

14. The method of claim 1 wherein transferring the small object from the first frame's receptacle to the second frame's receptacle includes moving the first frame in the second direction, adjacent the second frame.

15. The method of claim 1 wherein transferring the small object from the first frame's receptacle to the second frame's receptacle includes dropping the small object into the second frame's receptacle.

16. The method of claim 1 wherein transferring the small object from the first frame's receptacle to the second frame's receptacle includes holding the small object in the receptacle by applying a vacuum to a port in the first frame's receptacle.

17. The method of claim 1 wherein positioning the small object in the second frame's receptacle includes locating the second frame's receptacle immediately adjacent the first frame's receptacle before transferring the small object to the second frame's receptacle.

18. The method of claim 1 wherein positioning the small object in the second frame's receptacle includes positioning the small object on a platform of the receptacle that is movable relative to a wall of the receptacle.

19. A frame for holding a small object while coating the small object with a coating composition; the frame comprising:
a first plate including a platform having a longitudinal axis;
a second plate coupled to the first plate and movable relative to the first plate, the second plate including a wall adjacent a hole, wherein the hole receives the first plate's platform and is configured to allow the wall to move relative to the platform in a direction along the platform's longitudinal axis;
wherein the platform and wall define a receptacle of the frame operable to hold a small object.

20. The frame of claim 19 wherein:
the first plate includes a plurality of platforms each having a respective longitudinal axis, and
the second plate includes:
a plurality of holes each corresponding to a respective one of the first plate's platforms, and
a plurality of walls each corresponding to a respective one of the second plate's holes.

21. The frame of claim 19 wherein the second plate's wall surrounds the second plate's hole.

22. The frame of claim 19 wherein the second plate's wall includes an edge configured to cut a coating composition.

23. The frame of claim 19 wherein the first plate's platform includes a cylindrical shape.

24. The frame of claim 19 wherein the first frame's platform includes a bore aligned with the platform's longitudinal axis.

25. The frame of claim 19 wherein the receptacle includes a rectangular shape.

26. A system for coating a small object with a coating composition, the system comprising:
a first frame to hold a small object, the first frame comprising:
a first plate including a platform having a longitudinal axis,
a second plate coupled to the first plate and movable relative to the first plate, the second plate including a wall adjacent a hole, wherein the hole receives the first plate's platform and is configured to allow the wall to move relative to the platform in a direction along the platform's longitudinal axis,
wherein the platform and wall define a receptacle of the first frame to hold the small object;
a first conveyor operable to convey the first frame toward a second conveyor;
a first applicator operable to coat a small object held in the receptacle of the first frame with a coating composition;
a second frame to hold a small object, the second frame comprising:
a first plate including a platform having a longitudinal axis,
a second plate coupled to the first plate and movable relative to the first plate, the second plate including a wall adjacent a hole, wherein the hole receives the first plate's platform and is configured to allow the wall to move relative to the platform in a direction along the platform's longitudinal axis,
wherein the platform and wall define a receptacle of the second frame to hold the small object;
a second conveyor operable to convey the second frame toward a collector;
a transfer interface where, when a small object is held in the receptacle of the first frame, the small object is transferred to the receptacle of the second frame;
a second applicator operable to coat a small object held in the receptacle of the second frame with a coating composition.

27. The system of claim 26 wherein the first conveyor is disposed above the second conveyor, and the transfer interface lies between the first and second conveyors and includes a portion of the first conveyor above and immediately adjacent a portion of the second conveyor.

28. The system of claim 26 wherein the first conveyor includes a component to secure the small object in the first frame's receptacle as the first frame's receptacle enters the transfer interface.

29. The system of claim 28 wherein the component to secure the small object in the first frame's receptacle includes pump that generates a vacuum between the small object and the platform of the first frame's receptacle.

30. The system of claim 28 wherein:
gravity holds the small object in the first frame's receptacle as the first conveyor conveys the first frame toward the second conveyor,
gravity urges the small object from the first frame's receptacle and toward the second frame's receptacle, and
gravity holds the small object in the second frame's receptacle as the second conveyor conveys the second frame toward the collector.
